(19) United States
(12) Patent Application Publication
(10) Pub. No.: US 2020/0394697 A1
(43) Pub. Date: Dec. 17, 2020

(54) METHODS AND SYSTEMS FOR ARTIFICIAL INTELLIGENCE INSIGHTS FOR RETAIL LOCATION

(71) Applicant: SHOPPERTRAK RCT CORPORATION, Chicago, IL (US)

(72) Inventors: Michael PAOLELLA, Lake Zurich, IL (US); Michelangelo PALELLA, Chicago, IL (US)

(21) Appl. No.: 16/439,281

(22) Filed: Jun. 12, 2019

(51) Int. Cl. G06Q 30/06; G06N 20/00; G06N 5/02

(52) U.S. Cl. CPC G06Q 30/0623; G06N 5/02; G06N 20/00

(57) ABSTRACT

Examples described herein generally relate to a system for managing a retail environment. The system may collect data from a plurality of retail information systems including at least an inventory system, a loss prevention system, and a retail traffic system. The system may predict a condition based on a machine-learning model applied to a combination of the collected data from at least two systems of the plurality of retail information systems. The system may push an alert to a user identifying the condition and a recommended action, the user having a user persona matching a persona associated with the condition.

### BACKGROUND

The present disclosure relates to managing retail locations, and more particularly to real time insights for managing retail locations.

Retailers may collect data regarding events within a retail location. Conventionally, the collected data may be analyzed to determine ways to improve the retail location.

Some retails may have real-time access to a limited set of data such as inventory data. Employees may use a computer system to look up specific information such as a number of items in stock, a location of the item, or a price of the item. Such systems, however, typically require a dedicated employee to operate the system and answer questions from other employees.

Thus, there is a need in the art for improvements in responding to events at a retail location. In particular, there is a need for systems and methods for providing useful real-time condition information to employees who may be performing other tasks.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an example, the disclosure provides a method of managing a retail environment. The method may include collecting data from a plurality of retail information systems including at least an inventory system, a loss prevention system, and a retail traffic system. The method may include predicting a condition based on at least one machine-learning model and a combination of the collected data from at least two systems of the plurality of retail information systems. The method may include pushing an alert to a user identifying the condition and a recommended action, the user having a user persona matching a persona associated with the condition.

In another aspect, the disclosure provides a non-transitory computer readable medium storing computer executable instructions that when executed by a processor cause the processor to generate alerts for a retail environment. The non-transitory computer readable medium may include instructions to collect data from a plurality of retail information systems including at least an inventory system, a loss prevention system, and a retail traffic system. The non-transitory computer readable medium may include instructions to predict a condition based on at least one machine-learning model and a combination of the collected data from at least two systems of the plurality of retail information systems. The non-transitory computer readable medium may include instructions to push an alert to a user identifying the condition and a recommended action, the user having a user persona matching a persona associated with the condition. 1000811n another aspect, the disclosure provides a system for managing a retail environment. The system may include a plurality of retail information systems including at least an inventory system, a loss prevention system, and a retail traffic system. The system may include a computer system comprising a memory storing computer executable instructions and a processor configured to execute the instructions. The processor may collect data from the plurality of retail information systems. The processor may predict a condition based on a machine-learning model and a combination of the collected data from at least two systems of the plurality of retail information systems. The processor may push an alert to a user identifying the condition and a recommended action, the user having a user persona matching a persona associated with the condition.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a schematic diagram of an example retail management system.

FIG. 2 is a diagram of an example computer system implementing a retail management system.

FIG. 3 is a flowchart of an example method of for providing alerts regarding a retail location, in accordance with an implementation of the present disclosure;

FIG. 4 is a flowchart of an example method of training a machine-learning model to detect deviations from a pattern, in accordance with an implementation of the present disclosure;

FIG. 5 is a flowchart of an example method of training a machine-learning model to predict events, in accordance with an implementation of the present disclosure;

FIG. 6 is a schematic block diagram of an example computer device, in accordance with an implementation of the present disclosure.

### DETAILED DESCRIPTION

The present disclosure provides systems and methods for managing a retail location. In particular, a employees at a retail location may perform numerous tasks such as replenishing inventory levels, answering customer questions, locating products, distributing promotions, processing payments, preventing losses due to damage and theft, and other tasks depending on the type of retail location. Conventionally, such employees do not have access to data collected by multiple information systems within the retail environment. Although an employee may interact with a specific system, the employee typically is only provided with specific information requested through a particular interface.

In an aspect, the present disclosure provides retail management systems and methods for answering queries and providing dynamic alerts to various users (e.g., store personnel). The retail management system may collect data from a plurality of retail information systems including at least an inventory system, a loss prevention system, and a retail traffic system. Other example information systems such as entertainment systems, weather services, scheduling services, and transportation services may also provide data. The retail management system may predict a condition based on a machine-learning model applied to a combination of the collected data from at least two systems of the plurality of retail management systems. Accordingly, the alerts may be determined based on dynamic conditions that do not require fixed thresholds. The retail management system may push an alert to a user identifying the condition and a recommended action, the user having a user persona matching a persona associated with the condition. The alerts may be based on prescriptive analytics that allow the user to address a predicted condition before the condition occurs. Accordingly, the system may improve the information access of the users and improve productivity within a retail location.

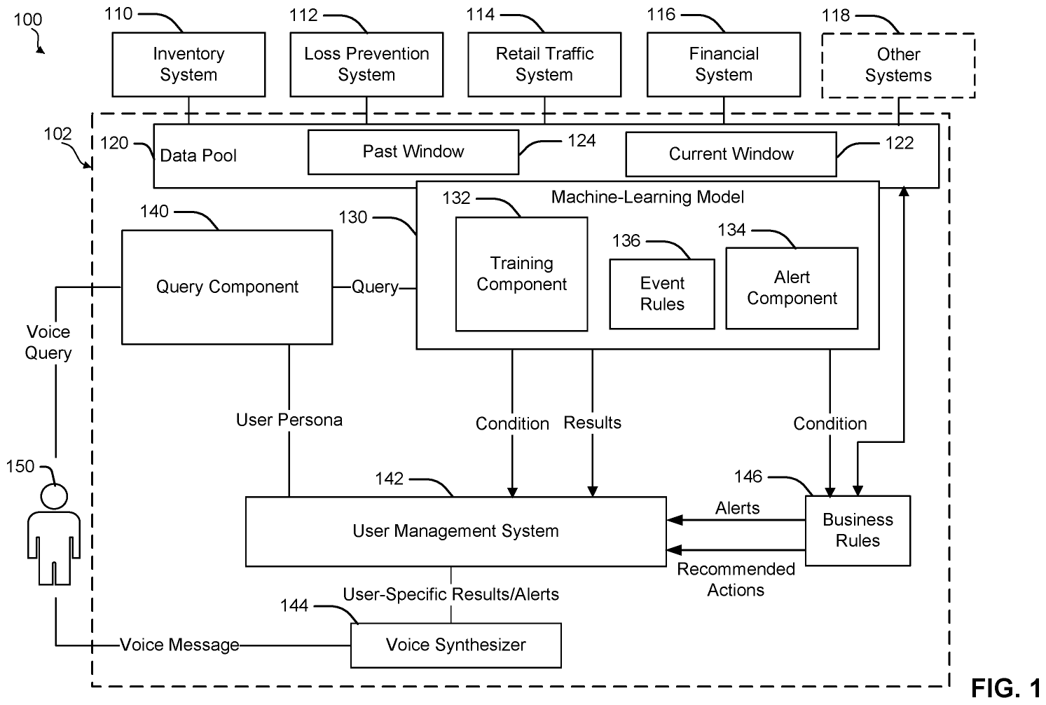

Referring now to FIG. 1, an example retail management system 100 may answer queries from one or more users 150 and autonomously provide alerts to the one or more users 150. The users 150 may include employees at a retail location. In an aspect, each of the users 150 may be provided with a wireless headset including a microphone and speakers for voice communication. The users 150 may issue voice commands and voice queries to the retail management system 100 and receive synthesized voice responses. In an aspect, users 150 may use a computer (e.g., terminal or mobile device) to issue commands or queries, and receive responses. For example, a user 150 may request a report and receive the requested information as a response via the wireless headset and/or as a message or document sent to a computer. A user 150 (e.g., a manager) may also manage the retail management system 100 via voice commands or the computer. For example, the user 150 may set targets or goals, allocate responsibilities or user personas, and make decisions.

The retail management system 100 may receive input from various retail information systems, some of which may perform other tasks at a retail location. For example, the retail management system 100 may receive input from two or more of an inventory system 110, a loss prevention system 112, a retail traffic system 114, a financial system 116, and other systems 118.

The inventory system 110 may track item quantities or specific items at different locations and/or at different stages of retail. For example, the inventory system 110 may determine a number of items in transit, in a back-room, and on a sales floor. The inventory system 110 may also track purchase of items. In an aspect, the inventory system 110 may use RFID tags, EPC tags, or barcodes to track items.

The loss prevention system 112 may deter theft of items and may identify individuals associated with losses. For example, the loss prevention system 112 may include security devices attached to individual items and monitoring devices located near exits. The loss prevention system 112 may include removal and deactivation devices that may be located at one or more registers. The monitoring devices may generate alerts when merchandise passes an exit without the security device being removed or deactivated. The loss prevention system 112 may include security cameras that monitor various zones of the retail location. In an aspect, the loss prevention system 112 may include a recognition system that identifies individuals, in particular, individuals that are identified in a database as being associated with losses. For example the recognition system may recognize faces in videos, mobile devices attempting to connect to a store network, or individuals based on profiles including multiple characteristics. In another aspect, the loss prevention system 112 may include a wireless network device that identifies mobile devices. The loss prevention system 112 may identify devices associated with losses.

The retail traffic system 114 may determine the location of customers within a retail location. The retail traffic system 114 may, for example, include cameras that determine a number of people within a zone of the retail location. A zone may be defined as particular region or based on a camera (e.g., within a field of view of the camera). The retail traffic system 114 may compare the number of people over time to determine customer traffic rates for different zones of the retail location. In an aspect, the retail traffic system 114 may differentiate between store employees and customers to provide more specific traffic information.

The financial system 116 may determine various financial data related to the retail location. For example, the financial system 116 may collect information for all checkout transactions at the retail location to determine revenue over any period. For example, the period may be a quarter-hour, half-hour, hour, by shift, day, weekend, week, or longer periods. The financial system 116 may determine costs such as labor costs, energy costs, and inventory costs.

The other systems 118 may include any other system that provides input to the retail management system 100. In an aspect, the other systems 118 may include external systems that provide a service. Examples of other systems 118 may include entertainment systems (e.g., radio or streaming services), weather services, scheduling services, and transportation services.

The retail management system 100 may include a data pool 120 that stores relevant data collected by the various systems. For example, the data pool 120 may receive all data generated by the various systems and apply business rules to manage the data. For instance, the data pool 120 may aggregate data and implement retention policies based on a data type. For example, the data pool 120 may receive item or transaction level details from an inventory management system. The data pool 120 may store such detailed information as a current window 122 for a retention period (e.g., one week) and generate aggregates such as totals, rates, and averages. The data pool 120 may store previous current windows 122 as past windows 124. The data pool 120 may store the detailed information for a number of past windows 124 equal to the retention period. The data pool 120 may retain the aggregates after the retention period and delete the detailed information.

The retail management system 100 may include one or more machine-learning models 130. The machine-learning models 130 may be trained to detect conditions and/or respond to queries. For example, the machine-learning models 130 may include one or more training components 132, an alert component 134, and event rules 136. The training component 132 may train the one or more machine-learning models 130 based on the data pool 120. The alert component 134 may evaluate a current window 122 of the data pool 120 against the trained model to predict conditions. That is, the alert component 134 may apply the one or more trained machine-learning models 130 to the current window 122, to determine whether the machine-learning model predicts a condition based on the current data. In the case of multiple machine-learning models, the multiple models may be applied in parallel. In an aspect, the machine-learning models 130 may be arranged in a hierarchical manner in which a higher level model selects results from a plurality of lower level models (e.g., one model for each event or alert).

As a first example, the training component 132 may apply a supervised learning technique. The training component 132 may be configured with event rules 136, which may be business rules that identify an event. For example, a business rule may identify an item shortage event as occurring whenever an on-floor inventory level of an item falls below a threshold number. The training component 132 may identify item shortage events and generate a training data set based on the data pool 120 at a time prior to the event. The training component 132 may then use supervised learning to train the machine-learning model 130 to classify a current window 122 of the data pool 120 to determine a likelihood of the event occurring. The alert component 134 may periodically test the current window 122 against the machine-learning model 130 and generate an alert when the current window 122 is classified as predicting an event (e.g., the likelihood is greater than threshold). Other example events that may be defined by business rules include: check-out delays, long customer queue lengths, criminal activity (e.g., unexpected losses), low conversion rates, high consumption rates, and traffic levels that are lower or higher than expected.

As a second example, the training component 132 may utilize unsupervised learning to identify a pattern in the data pool 120. For example, the training component 132 may correlate data elements over time to determine a periodicity. For example, at a particular retail location, the training component 132 may detect a periodic pattern for Saturday afternoons between 1 pm and 3 pm where under certain conditions (e.g., the temperature is above 80 degrees and sunny and foot traffic is over 50% male) the rate of sale of a product (e.g., sunglasses or flip-flops) is 10 items per hour. The specific pattern and conditions would vary by retail location. The alert component 134 may then monitor the data elements in the current window 122 to determine a deviation of current data collected from an expected pattern. For example, if the rate of sale of the product were lower than expected, the alert component 134 may generate an alert to check if the items are displayed properly.

The retail management system 100 may include a query component 140. The query component 140 may receive a query from a user 150 in the form of a voice query and/or a computer query. The query or associated information may identify the user 150. The query component 140 may determine a user persona for the user 150, for example, in communication with a user management system 142. In the case of a voice query, the query component 140 may interpret the voice query based on the user persona to generate a machine query. For example, the query component 140 may convert the voice query to a text query using a limited vocabulary defined for the user persona. Additionally, the user persona may be associated with a limited set of query types that may be executed by the user persona. The query component 140 may determine a query type and parameters based on the text query to generate the machine query. For computer queries, a user interface on the device of the user 150 may be used to generate an appropriate machine query for the user 150. The query component 140 may submit the machine query to the machine-learning model 130.

The retail management system 100 may include a user management system 142. The user management system 142 may define multiple users 150 and associate each user 150 with a user persona. For example, a user persona may be based on a job title, assigned role, or scheduled activity. The user management system 142 may provide the user persona to the query component 140. The user management system 142 may receive alerts and query results from the machine-learning model 130. The alerts and query results may identify a recipient (e.g., the querying user) or a user persona. The user management system 142 may identify a user 150 to receive the alert or query result and provide the identity with the alert or query result to the voice synthesizer 144. For example, a user persona associated with a low inventory condition may be an inventory manager or stocking person. The user management system 142 may identify an employee currently fulfilling the user persona to receive the alert.

The voice synthesizer 144 may generate a voice response based on the query result or alert and the user persona. For example, the voice synthesizer 144 may generate a text sentence conveying the query result or alert. The voice synthesizer 144 may convert the text sentence to the voice message. In an aspect, the voice synthesizer 144 may provide the text sentence to a display device of the user 150.

The retail management system 100 may include business rules 146. The business rules 146 may be applied directly to the data pool 120 and/or the current window 122. The business rules 146 may be configured to detect the occurrence of specific events. For example, the business rules 146 may determine that a condition has already occurred (e.g., an item is out of stock). The business rules 146, however, may not be able to predict events that are likely to occur. For example, it would be difficult to create a business rule that predicts a rate of sale of an item.

In an aspect, the business rules 146 may define a recommended action in response to a detected event. For example, a business rule 146 may be configured for each type of event and may use information about the predicted condition to provide a specific recommended action. For example, a prediction of low traffic levels (e.g., due to weather) may be associated with a flash marketing action to incentive visits to the retail location. As another example, a prediction of high traffic levels may be associated with a recommendation to shift staff into customer assistance locations. As yet another example, conditions associated with an individual customer (e.g., predicted criminal action or long dwell time) may be associated with a recommendation to send an appropriate staff member to meet the individual customer. The business rules 146 for the recommended actions may be configured for the individual retail location. In an aspect, the machine learning model 130 may be trained based on results of recommended actions, for example, to determine whether the recommended actions resulted in meeting goals. The machine learning model 130 may provide suggested modifications to the business rules 146, for example, if a recommended action associated with an event actually leads to negative results. For example, if a recommendation to reassign staff to address a condition leads to negative effects to the original role off the staff, the machine learning model 130 may suggest reducing the number of staff to reassign.

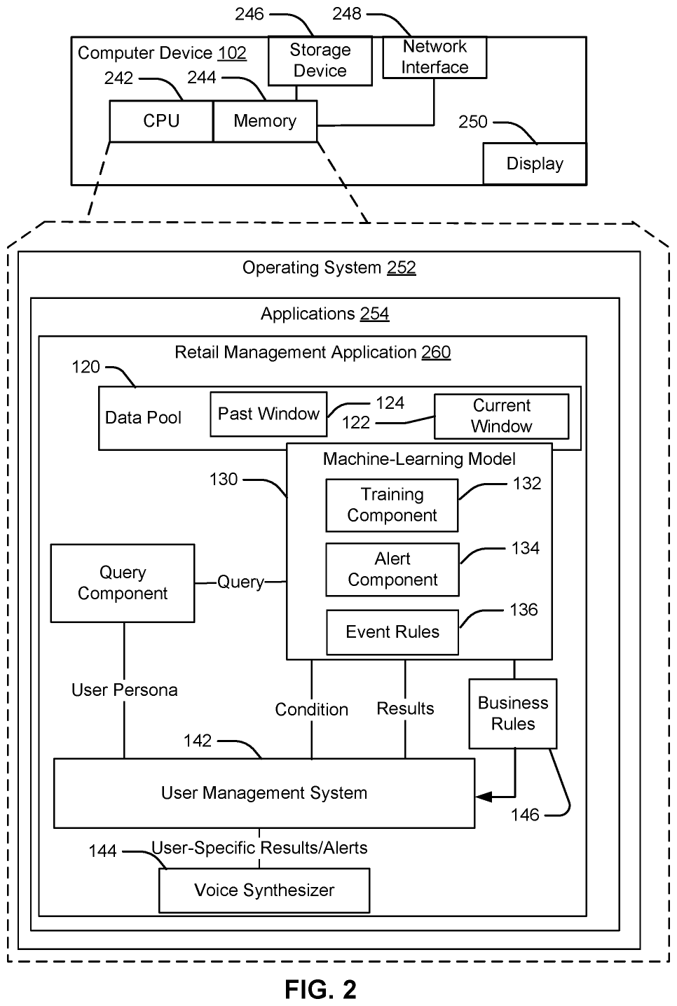

Turning to FIG. 2, in an example implementation, a computer device 102 may implement various components of the retail management system 100. The computer device 102 may be, for example, any mobile or fixed computer device including but not limited to a computer server, desktop or laptop or tablet computer, a cellular telephone, a personal digital assistant (PDA), a handheld device, any other computer device having wired and/or wireless connection capability with one or more other devices.

The computer device 102 may include a central processing unit (CPU) 242 that executes instructions stored in memory 244. For example, the CPU 242 may execute an operating system 252 and one or more applications 254, which may include a retail management application 260. The computer device 102 may include a storage device 246 for storing data (e.g., data pool 120). The computer device 102 may also include a network interface 248 for communication with external devices via a network. For example, the computer device 102 may communicate with the inventory system 110, loss prevention system 112, retail traffic system 114, financial system 116, and/or other systems 118 via the network interface 248.

The computer device 102 may include a display 250. The display 250 may be, for example, a computer monitor, device screen, and/or a touch-screen. The display 250 may provide information to an operator and allow the operator to configure the computer device 102.

Memory 244 may be configured for storing data and/or computer-executable instructions defining and/or associated with an operating system 252 and/or application 254, and CPU 242 may execute operating system 252 and/or application 254. Memory 244 may represent one or more hardware memory devices accessible to computer device 102. An example of memory 244 can include, but is not limited to, a type of memory usable by a computer, such as random access memory (RAM), read only memory (ROM), tapes, magnetic discs, optical discs, volatile memory, non-volatile memory, and any combination thereof. Memory 244 may store local versions of applications being executed by CPU 242. In an implementation, the memory 244 may include a storage device, which may be a non-volatile memory.

The CPU 242 may include one or more processors for executing instructions. An example of CPU 242 can include, but is not limited to, any processor specially programmed as described herein, including a controller, microcontroller, application specific integrated circuit (ASIC), field programmable gate array (FPGA), system on chip (SoC), or other programmable logic or state machine. The CPU 242 may include other processing components such as an arithmetic logic unit (ALU), registers, and a control unit. The CPU 242 may include multiple cores and may be able to process different sets of instructions and/or data concurrently using the multiple cores to execute multiple threads.

The operating system 252 may include instructions (such as applications 254) stored in memory 244 and executable by the CPU 242. The applications 254 may include a retail management application 260. The retail management application 260 may manage the data pool 120, which may be stored in storage device 246. The retail management application 260 may include executable instructions for implementing the machine-learning model 130, the training component 132, the alert component 134, the query component 140, the user management system 142, and the voice synthesizer 144, as discussed above. Additionally, the retail management application may be configured with the event rules 136 and the business rules 146, as discussed above.

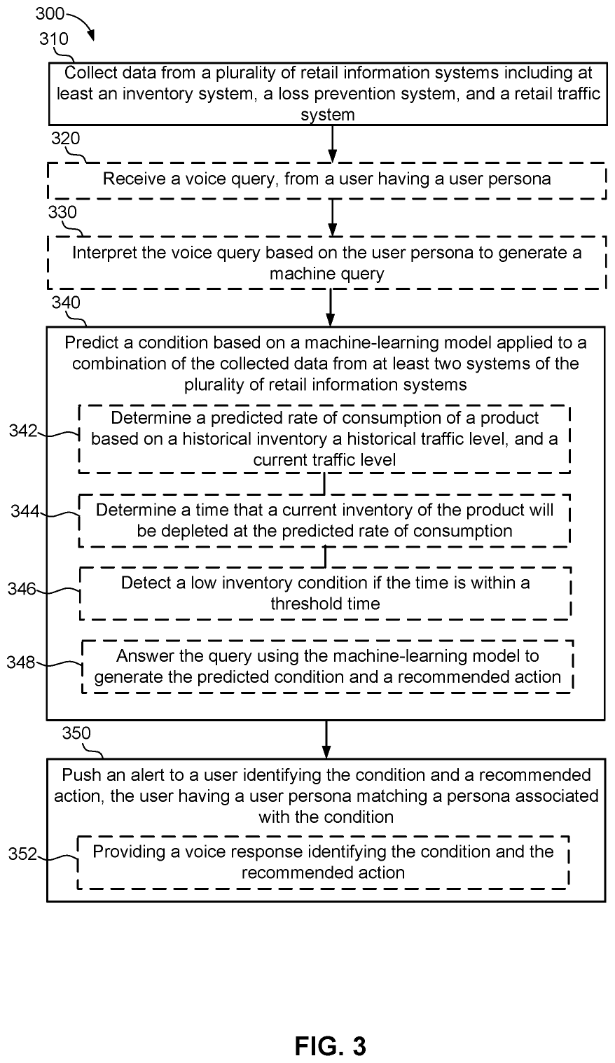

Turning to FIG. 3, an example method 300 generates notifications to one or more users 150 regarding a retail location. For example, method 300 may be performed by the retail management system 100 on the computer device 102. Optional blocks are shown with dashed lines.

At block 310, the method 300 may optionally include collecting data from a plurality (two or more) of retail information systems including at least an inventory system, a loss prevention system, and a retail traffic system. In an aspect, for example, the data pool 120 may collect data from a plurality of retail information systems including at least two of an inventory system 110, a loss prevention system 112, and a retail traffic system 114.

At block 320, the method 300 may optionally include receiving a voice query, from a user having a user persona. In an aspect, for example, the query component 140 may receive a voice query, from the user 150 having the user persona.

At block 330, the method 300 may optionally include interpreting the voice query based on the user persona to generate a machine query for a predicted condition. In an aspect, for example, the query component 140 may interpret the voice query based on the user persona to generate the machine query.

At block 340, the method 300 may include predicting a condition based on a machine-learning model applied to a combination of the collected data from at least two systems of the plurality of retail information systems. In an aspect, for example, the machine-learning model 130 may detect the condition based on a combination of the collected data from at least two systems of the plurality of retail information systems. For example, the data may be data that is stored in the data pool 120.

At sub-block 342, the block 340 may optionally include determining a predicted rate of consumption of a product based on historical inventory levels, historical traffic levels, and a current traffic level. The historical inventory levels may be determined from the inventory system 110 for the retail location. The historical traffic level and the current traffic level may be determined by the retail traffic system 114 for the current location. The machine-learning model 130 may determine the predicted rate of consumption of the product, which may be specific to the retail location. At sub-block 344, the block 340 may optionally include determining a time that a current inventory of the product will be depleted at the predicted rate of consumption. For example, the machine-learning model 130 may determine the time that the current inventory of the product (which may be based on the inventory system 110) will be depleted at the predicted rate of consumption. At sub-block 346, the block 340 may optionally include detecting a low inventory condition if the time is within a threshold time. For example, the alert component 134 may detect the low inventory condition if the time is within a threshold time. In an aspect, the threshold time may be a store closing time. Accordingly, the machine-learning model 130 may predict low inventory conditions for items that are likely to run out while the retail location is open to prioritize replenishment over items that may be replenished after the retail location closes. In another aspect, the alert component 134 may prioritize low inventory conditions based on the predicted time.

In another aspect, at sub-block 348, the block 340 may optionally include answering the query using the machine-learning model to generate the predicted condition and a recommended action. In an aspect, for example, the machine-learning model 130 may receive a machine query. The machine-learning model 130 may evaluate the current window 122 based on the query and generate one or more predicted conditions. The business rules 146 may generate the recommended action. For example, the business rules 146 may define a recommended action for each condition.

At block 350, the method 300 may include pushing an alert to a user identifying the condition and a recommended action, the user having a user persona matching a persona associated with the condition. In an aspect, for example, the user management system 142 may push an alert to the user 150 identifying the condition and a recommended action, the user 150 having a user persona matching a persona associated with the condition. For example, based on the condition detected by the machine-learning model, the user management system 142 may query the business rules 146 for a corresponding recommended action and/or user persona associated with the condition. The user management system 142 may identify a user 150 matching the user persona associated with the condition. For example, if the condition is a predicted theft, the associated user persona may be a security officer, and the user management system 142 may determine the current security officer.

At sub-block 352, the method 300 may optionally include providing a voice response identifying the condition and the recommended action. In an aspect, for example, the voice synthesizer 144 may provide the voice response identifying the condition and the recommended action to the user 150 that initiated the voice query.

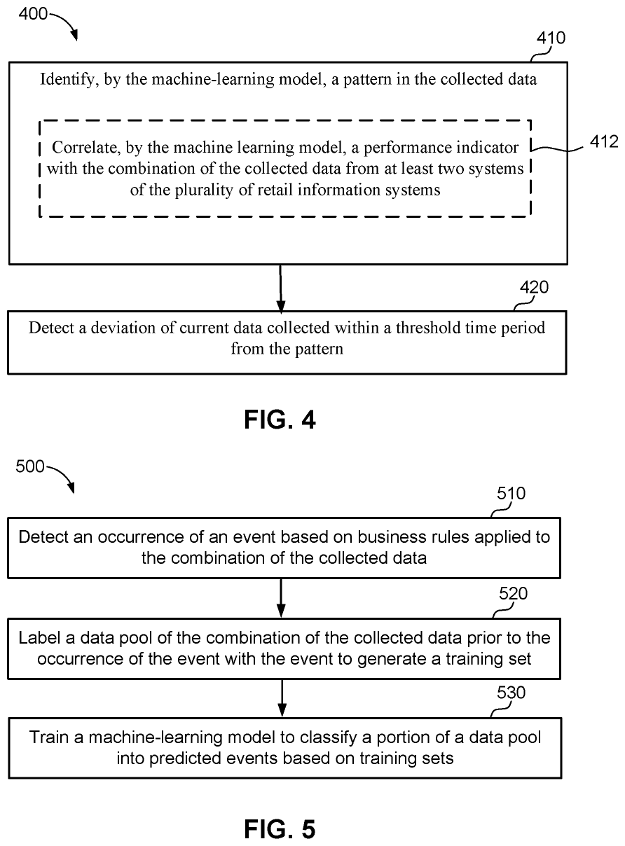

Turning to FIG. 4, an example method 400 may be used for training a machine-learning model to detect conditions at a retail location. For example, method 400 may be performed by the retail management system 100 on the computer device 102. Optional blocks are shown with dashed lines.

At block 410, the method 400 may include identifying, by the machine-learning model, a pattern in the collected data. In an aspect, for example, the training component 132 may identify the pattern in the collected data. In an aspect, the training component 132 may implement unsupervised techniques to identify patterns. The unsupervised techniques may discover correlations among the data elements from the different retail information systems. In an aspect, at sub-block 412, the block 410 may include correlate, by the machine learning model, a performance indicator with the combination of the collected data from at least two systems of the plurality of retail information systems. In an aspect, for example, the training component 132 may train the machine-learning model 130 by correlating the performance indicator with the combination of collected data from the at least two systems of the plurality of retail information systems. For example, the performance indicator may be provided by a financial system and may include a measurement such as revenue, profit, or number of transactions during a time period. The training component 132 may determine which combinations of data elements correlate with strong or weak values for the performance indicator.

At block 420, the method 400 may include detecting a deviation of current data collected within a threshold time period from the pattern. In an aspect, for example, the alert component 134 may detect the deviation of the data in the current window 122 from the pattern. For example, the alert component 134 may determine whether data elements in the current window 122 deviate from typical values for a current time of day and/or day of week. The alert component 134 may determine whether data elements in the current window 122 correspond to or deviate from the values correlated with strong or weak values for the performance indicator.

Turning to FIG. 5, an example method 500 trains a machine-learning model to detect conditions at a retail location. For example, method 500 may be performed by the retail management system 100 on the computer device 102. Optional blocks are shown with dashed lines.

At block 510, the method 500 may include detecting an occurrence of an event based on business rules applied to the combination of the collected data. In an aspect, for example, the training component 132 may detect an event based on event rules 136. For example, the training component 132 may compare the current window 122 to determine whether data satisfies a condition indicated by the event rules 136. The event rules 136 may define an event based on relatively few data elements. For example, a low inventory event for an item may be defined as an on-floor quantity of the item being less than a threshold number, so the training component 132 may identify an event that has occurred based on, for example, a single data element.

At block 520, the method 500 may include labeling a data pool of the combination of the collected data prior to the occurrence of the event with the event to generate a training set. For example, the training component 132 may label a portion of the data pool 120 with the event. In an aspect, the portion of the data pool 120 may be a past window 124 that includes a set of data at a time prior to the event occurring. For example, the past window 124 may be a stored copy of a current window 122 for a defined period prior to the event being detected. The event rule 136 may define the period prior to the event. Accordingly, when an event is detected, the training component 132 may label a stored copy of a previous current window 122 stored as a past window 124 with the detected event.

At block 530, the method 500 may include training a machine-learning model to classify a portion of a data pool into predicted events based on training sets. In an aspect, for example, the training component 132 may train the machine-learning model 130 to classify the current window 122 into predicted events based on the training sets. That is, when the trained machine-learning model 130 is provided with the current window 122, the trained machine-learning model 130 may determine a probability of each of the events on which the trained machine-learning model 130 was trained occurring.

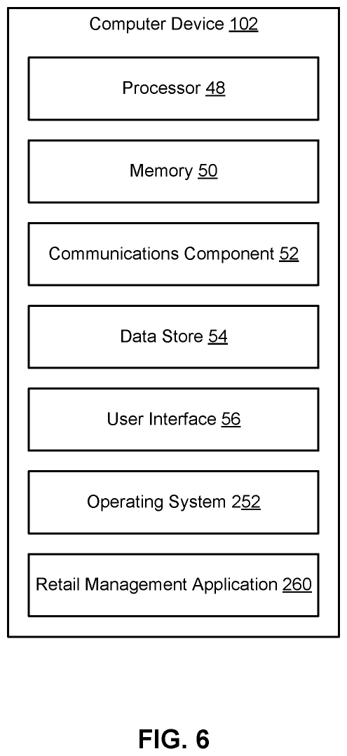

Referring now to FIG. 6, illustrated is an example computer device 102 in accordance with an implementation, including additional component details as compared to FIG. 2. In one example, computer device 102 may include processor 48 for carrying out processing functions associated with one or more of components and functions described herein. Processor 48 can include a single or multiple set of processors or multi-core processors. Moreover, processor 48 can be implemented as an integrated processing system and/or a distributed processing system. In an implementation, for example, processor 48 may include CPU 242.

In an example, computer device 102 may include memory 50 for storing instructions executable by the processor 48 for carrying out the functions described herein. In an implementation, for example, memory 50 may include memory 244. The memory 50 may include instructions for executing the retail management application 260.

Further, computer device 102 may include a communications component 52 that provides for establishing and maintaining communications with one or more parties utilizing hardware, software, and services as described herein. Communications component 52 may carry communications between components on computer device 102, as well as between computer device 102 and external devices, such as devices located across a communications network and/or devices serially or locally connected to computer device 102. For example, communications component 52 may include one or more buses, and may further include transmit chain components and receive chain components associated with a transmitter and receiver, respectively, operable for interfacing with external devices.

Additionally, computer device 102 may include a data store 54, which can be any suitable combination of hardware and/or software, that provides for mass storage of information, databases, and programs employed in connection with implementations described herein. For example, data store 54 may be a data repository for operating system 252 and/or applications 254. The data store may include memory 244 and/or storage device 246.

Computer device 102 may also include a user interface component 56 operable to receive inputs from a user of computer device 102 and further operable to generate outputs for presentation to the user. User interface component 56 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, user interface component 56 may include one or more output devices, including but not limited to a display, a speaker, a haptic feedback mechanism, a printer, any other mechanism capable of presenting an output to a user, or any combination thereof

In an implementation, user interface component 56 may transmit and/or receive messages corresponding to the operation of operating system 252 and/or applications 254. In addition, processor 48 may execute operating system 252 and/or applications 254, and memory 50 or data store 54 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. A person skilled in the art should understand and appreciate that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. For example, a tensor processing unit (TPU) may implement the one or more machine learning models 130 discussed above. In an aspect, a graphical processing unit (GPU) may be programmed to perform aspects of the present disclosure, for example, where parallel operations occur. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium (e.g., a non-transitory computer-readable medium) may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a non-transitory machine readable medium and/or non-transitory computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A method of managing a retail environment, comprising:
collecting data from a plurality of retail information systems including at least an inventory system, a loss prevention system, and a retail traffic system;
predicting a condition based on at least one machine-learning model and a combination of the collected data from at least two systems of the plurality of retail information systems; and
pushing an alert to a user identifying the condition and a recommended action, the user having a user persona matching a persona associated with the condition.

2. The method of claim 1, further comprising:
receiving a voice query, from the user having the user persona;
interpreting the voice query based on the user persona to generate a machine query for a predicted condition;
answering the query using the at least one machine-learning model to generate a predicted condition and a recommended action; and
providing a voice response identifying the answer and the recommended action.

3. The method of claim 1, wherein predicting the condition comprises:
determining a predicted rate of consumption of a product based on historical inventory levels, a historical traffic level, and a current traffic level;
determining a time that a current inventory of the product will be depleted at the predicted rate of consumption; and
detecting a low inventory condition if the time is within a threshold time.

4. The method of claim 1, wherein predicting the condition comprises:
identifying, by the at least one machine-learning model, a pattern in the collected data; and
detecting a deviation of current data collected within a threshold time period from the pattern.

5. The method of claim 4, wherein identifying the pattern comprises, correlating by the at least one machine learning model, a performance indicator with the combination of the collected data from at least two systems of the plurality of retail information systems.

6. The method of claim 1, wherein the at least one machine-learning model is trained on training sets that are subsets of the data from the plurality of retail information systems that have been labeled with corresponding events.

7. The method of claim 6, further comprising:
detecting an occurrence of an event based on business rules applied to the combination of the collected data;
labeling a data pool of the combination of the collected data prior to the occurrence of the event with the event to generate one of the training sets; and
training the at least one machine learning model to classify a current combination of the collected data into events based on the training sets.

8. A non-transitory computer readable medium storing computer executable instructions that when executed by a processor cause the processor to:
collect data from a plurality of retail information systems including at least an inventory system, a loss prevention system, and a retail traffic system;
predict a condition based on at least one machine-learning model and a combination of the collected data from at least two systems of the plurality of retail information systems; and
push an alert to a user identifying the condition and a recommended action, the user having a user persona matching a persona associated with the condition.

9. The non-transitory computer readable medium of claim 8, further comprising code to:
receive a voice query, from the user having the user persona;
interpret the voice query based on the user persona to generate a machine query for a predicted condition;
answer the query using the at least one machine-learning model to generate an answer and a recommended action; and
provide a voice response identifying the answer and the recommended action.

10. The non-transitory computer readable medium of claim 8, wherein the code to predict the condition comprises code to:
determine a predicted rate of consumption of a product based on a historical inventory a historical traffic level, and a current traffic level;
determine a time that a current inventory of the product will be depleted at the predicted rate of consumption; and
detect a low inventory condition if the time is within a threshold time.

11. The non-transitory computer readable medium of claim 8, wherein the code to predict the condition comprises code to:
identify, by the at least one machine-learning model, a pattern in the collected data; and
detect a deviation of current data collected within a threshold time period from the pattern.

12. The non-transitory computer readable medium of claim 11, wherein the code to identify the pattern comprises code to correlate, by the at least one machine learning model, a performance indicator with the combination of the collected data from at least two systems of the plurality of retail information systems.

13. The non-transitory computer readable medium of claim 8, wherein the machine-learning model is trained on training sets that are subsets of the data from the plurality of retail information systems that have been labeled with corresponding events.

14. The non-transitory computer readable medium of claim 13, further comprising code to:
detect an occurrence of an event based on business rules applied to the combination of the collected data;
label a data pool of the combination of the collected data prior to the occurrence of the event with the event to generate one of the training sets; and
train the machine learning model to classify a current combination of the collected data into events based on the training sets.

15. A system for managing a retail environment, comprising:
a plurality of retail information systems including at least an inventory system, a loss prevention system, and a retail traffic system; and
a computer system comprising a memory storing computer executable instructions and a processor configured to execute the instructions to:
collecting data from the plurality of retail information systems;
predict a condition based on a machine-learning model and a combination of the collected data from at least two systems of the plurality of retail information systems; and
push an alert to a user identifying the condition and a recommended action, the user having a user persona matching a persona associated with the condition.

16. The system of claim 15, wherein the processor is configured to execute the instructions to:
receive a voice query, from the user having the user persona;
interpret the voice query based on the user persona to generate a machine query for a predicted condition;
answer the query using the machine-learning model to generate an answer and a recommended action; and
provide a voice response identifying the answer and the recommended action.

17. The system of claim 15, wherein the processor is configured to execute the instructions to:
determine a predicted rate of consumption of a product based on a historical inventory a historical traffic level, and a current traffic level;
determine a time that a current inventory of the product will be depleted at the predicted rate of consumption; and
detect a low inventory condition if the time is within a threshold time.

18. The system of claim 15, wherein the processor is configured to execute the instructions to:
identify, by the machine-learning model, a pattern in the collected data; and
detect a deviation of current data collected within a threshold time period from the pattern.

19. The system of claim 15, wherein the processor is configured to execute the instructions to correlate, by the machine learning model, a performance indicator with the combination of the collected data from at least two systems of the plurality of retail information systems.

20. The system of claim 15, wherein the processor is configured to execute the instructions to:
detect an occurrence of an event based on business rules applied to the combination of the collected data;
label a data pool of the combination of the collected data prior to the occurrence of the event with the event to generate a the training set; and
train the machine learning model to classify a current combination of the collected data into events based on the training set.
